(19) United States
(12) Patent Application Publication
(10) Pub. No.: US 2018/0281580 A1
(43) Pub. Date: Oct. 4, 2018

(54) Transmission Assembly for a Hybrid Vehicle

(71) Applicant: GM GLOBAL TECHNOLOGY OPERATIONS LLC, Detroit, MI (US)

(72) Inventors: Olaf Heldmann, Nierstein (DE); Christian Ruebsam, Loerzweiler (DE)

(73) Assignee: GM GLOBAL TECHNOLOGY OPERATIONS LLC, Detroit, MI (US)

(21) Appl. No.: 15/945,447

(22) Filed: Apr. 4, 2018

(30) Foreign Application Priority Data
Apr. 4, 2017 (DE) 102017003290.4

(51) Int. Cl. B60K 6/365; B60K 6/48; F16H 3/72; B60K 6/547; B60K 6/387

(52) U.S. Cl. CPC B60K 6/365; B60K 6/48; F16H 2057/02043; B60K 6/547; B60K 6/387; F16H 3/725

(57) ABSTRACT

A transmission assembly for a hybrid vehicle includes a gearbox having an input shaft configured to be coupled with an internal combustion engine, and a pinion shaft configured to be coupled with a chassis, and a switchable planetary gear having a first connecting shaft configured to be coupled with an electric machine and a second connecting shaft non-rotatably coupled to the pinion shaft of the gearbox.

### CROSS-REFERENCE TO RELATED APPLICATION

This application claims priority to German Patent Application No. 102017003290.4, filed Apr. 4, 2017, which is incorporated herein by reference in its entirety.

### TECHNICAL FIELD

The present disclosure pertains to a transmission assembly for a hybrid vehicle, in particular to a transmission assembly in a P3 configuration.

### BACKGROUND

Depending on where an electric machine is integrated into the drivetrain of a hybrid vehicle, a distinction is made between P1, P2, P3 or P4 configurations. These configurations differ with respect to their advantages and disadvantages, and to the requirements they place on the electric machine. In P1 and P2 configurations, the electric machine and internal combustion engine drive a gearbox via a common shaft. In the P2 configuration, this common shaft contains a clutch, which makes it possible to uncouple the internal combustion engine and drive the vehicle purely electrically. As long as this clutch is closed, the internal combustion engine and electric machine run at the same rotational speed. The fluctuation range for the rotational speed of the electric machine is the same as for the internal combustion engine, and enables a driving and regeneration operation of the electric machine at any vehicle speed, but with an efficiency limited by the respective losses of the gearbox.

Losses in efficiency owing to the gearbox can be avoided with a P3 configuration, in which the electric machine acts on the output of the gearbox. The rotational speed of the electric machine is here proportional to the vehicle speed, making it difficult to generate the necessary driving power using just the electric machine, in particular at low speeds, for example while parking or driving uphill.

While a strong gear reduction of the electric machine makes it possible to increase the power it can deliver at a low speed, a high driving speed then yields extremely high rotational speeds, which can damage or destroy the electric machine.

### SUMMARY

In accordance with the present disclosure, a compact transmission assembly for a hybrid vehicle is provided that both enables an efficient driving and recuperation operation, and can also provide a high electric driving power, even at a low driving speed.

In an embodiment of the present disclosure, a transmission assembly for a hybrid vehicle with a gearbox, which has an input shaft to be coupled to an internal combustion engine, and a pinion shaft to be coupled to a chassis, and with a switchable planetary gear having a first connecting shaft to be coupled to an electric machine, and a second connecting shaft non-rotatably coupled to the pinion shaft of the gearbox.

Coupling a ring gear either to a transmission housing or to a planetary carrier in the planetary gear makes it possible to realize a transmission ratio suitable for a high electric driving power at a low speed on the one hand, and a transmission ratio suitable for a driving and recuperation operation in a wide interval of higher driving speeds on the other.

The transmission ratio suitable for higher driving speeds is preferably the one in which the ring gear is coupled to the planetary carrier. In this position, the planetary gears are loss-free, since they do not roll on each other, but rotate together. Therefore, this position should be set during the predominant part of the transmission assembly operating time. In times of slow travel that normally comprise only a small portion of the overall operating time of the transmission assembly, frictional losses caused by the planetary gears unrolling are more easily tolerated.

It should further be possible to switch the planetary gear into a position in which the ring gear can freely turn. In this position, the torque transmission between the chassis and electric machine is interrupted; therefore, it can be selected to protect the electric machine at an extremely high driving speed.

A multi-plate clutch is preferably provided for coupling the ring gear to the transmission housing. A claw clutch can be provided in order to couple the ring gear to the planetary carrier, in particular in the form of a synchronizer comprised of gearboxes.

A monitoring unit can be provided for protecting the electric machine, which uncouples the first connecting shaft from the pinion shaft when a speed limit is exceeded, preferably by setting the ring gear to the freely rotatable position.

In order to lessen the requirements placed on the transmission ratio of the planetary gear, the second connecting shaft can be coupled to the pinion shaft via an idler gear of the drive shaft.

It is also possible to use this idler gear for one of the transmission stages of the gearbox, and for this purpose to couple it to the drive shaft with a synchronizer. The idler gear preferably meshes with a gear of the pinion shaft or a layshaft of the gearbox that is smaller than the idler gear. The idler gear is preferably larger than the plurality of gears on the drive shaft.

A reverse gear shaft can normally be shorter than other shafts, in particular than the drive shaft, of the gearbox. Space can thus be economized when accommodating the planetary gear by having it overlap with the reverse gear shaft in an axial direction.

### BRIEF DESCRIPTION OF THE DRAWINGS

The present disclosure will hereinafter be described in conjunction with the following drawing figures, wherein like numerals denote like elements.

FIG. 1 is a schematic view of a drivetrain of a vehicle with a transmission assembly according to the present disclosure; and

FIG. 2 is a schematic view of the planetary gear of the transmission assembly.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

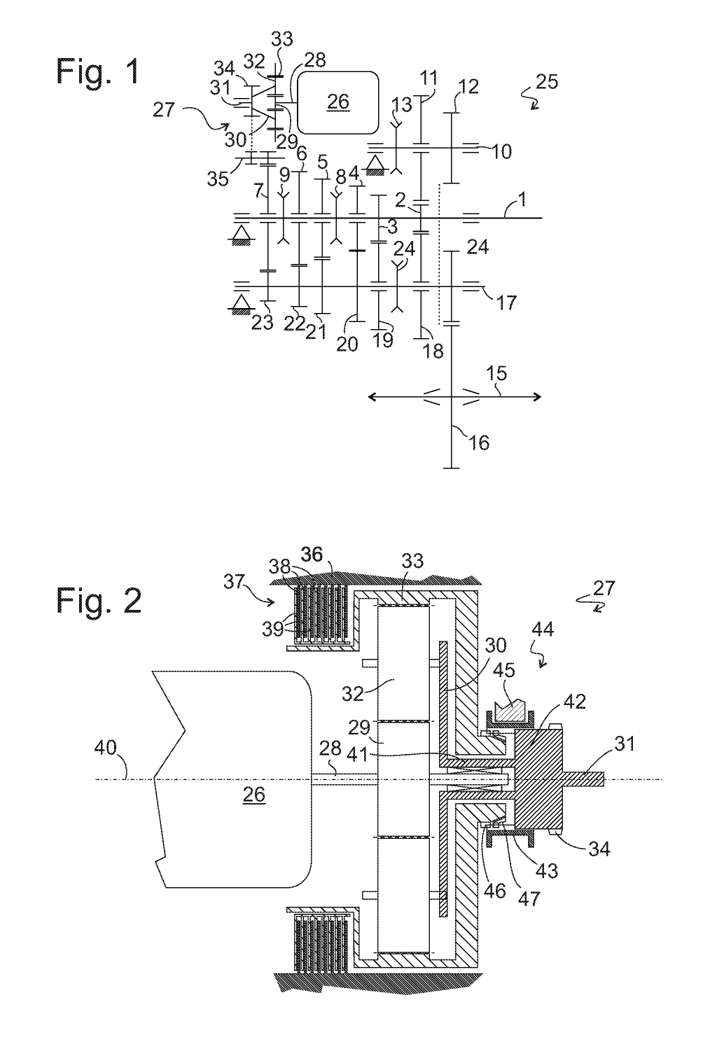

FIG. 1 shows the drivetrain of a hybrid vehicle. A drive shaft 1 of the drivetrain can be coupled to an internal combustion engine by way of a clutch, which is typically a multi-part clutch. The drive shaft 1 carries several gears 2-7, among them two as the fixed gears 2, 3, and the remaining, larger ones as idler gears 4-7. A respective dual-action locking synchronizer 8, 9 is located between two respective idler gears 4, 5 and 6, 7.

The smaller of the two fixed gears 2 simultaneously meshes with an idler gear 11 of a reverse gear shaft 10. A locking synchronizer 13 is used to non-rotatably couple the idler gear 11 to the reverse gear shaft 10. A drive pinion 12 of the reverse gear shaft 10 meshes with a gear 16 of a pinion shaft 15, as denoted on FIG. 1 by a dashed line.

A layshaft 17 carries idler gears 18, 19 that mesh with the fixed gears 2, 3, fixed gears 20-23 that mesh with the idler gears 4-7, a locking synchronizer 24 for coupling a respective one of the idler gears 18, 19 to the layshaft 17, and a drive pinion 24.

In a first gear of the gearbox 25 formed in this way, the locking synchronizer 24 couples the idler gear 18 to the layshaft 17, thereby transmitting the torque from the drive shaft 1 to the pinion shaft 15 via gears 2, 18, 24, 16. In a second gear, the locking synchronizer 24 couples the idler gear 19 to the layshaft 17, and torque is transmitted via the gears 3, 19, 24, and 16. In a third gear, the locking synchronizer 24 is in a neutral position; the locking synchronizer 8 instead couples the idler gear 4 to the drive shaft 1, and the torque flows via gears 4, 20, 24, 16. The expert can derive how additional gears are formed from FIG. 1, even with the inclusion of the additional locking synchronizer 9.

An electric machine 26 is connected to a first connecting shaft 28 of a planetary gear 27. The connecting shaft 28 carries a sun gear 29 of the planetary gear 27. A planetary carrier 30 is connected with a second connecting shaft 31. Planetary gears 32 mounted to the planetary carrier 30 each mesh in the usual manner with both the sun gear 29 and with a ring gear 33 that surrounds all planetary gears 32. A gear 34 of the connecting shaft 31, here by way of an axial displacement between it and the layshaft 35 that balances out the gear 7, is connected with the idler gear 7, and by way of the latter with the fixed gear 23 of the layshaft 17.

Viewed from a radial direction to the shafts 1, 17, etc., the reverse gear shaft 10 with the smallest gear 2 overlaps the drive shaft 1 and next adjacent gear 3. In order to economize on space when accommodating the electric machine 26, the latter is arranged in such a way as to overlap the drive shaft 1 or layshaft 17 as viewed in the radial direction, but not the reverse gear shaft 10. In order to be able to generate a high torque, the electric machine should not have too small a diameter. So as to accommodate the latter under prescribed external dimensions for the entire transmission, the electric machine 26 as viewed in the radial direction overlaps the smaller of those gears of the drive shaft 1 that do not overlap the reverse gear shaft 10, in the case of FIG. 1 gears 4, 5, 6, so that only the gear 7 is left for coupling the torque of the electric machine 26 into the transmission.

FIG. 2 presents a detailed diagram of the planetary gear 27. A shared housing for the gearbox 25 and planetary gear 27 is labeled 36. A first group of plates 38 of a multi-plate clutch 37 extending around an axis 40 of the electric machine is non-rotatably mounted on the housing 36. A second group of plates 39 is non-rotatably connected with the ring gear 33. One of the two groups, here the plates 39, can move along the axis 40 so as to open and close the multi-plate clutch 37.

In the illustration on FIG. 2, the clutch 37 along the axis 40 is arranged in a gap between the ring gear 33 and electric machine 26. Given a sufficient coupling surface, the external diameter of the clutch 37 can be kept low. Alternatively, depending on how the gears are arranged in the gearbox 25, an arrangement in which the multi-plate clutch 37 extends all around the ring gear 33 can also economize on more space.

The second connecting shaft 31 comprises a hollow shaft section 41 in which one end of the first connecting shaft 28 is rotatably mounted. The planetary carrier 30 is arranged on an end of the hollow shaft section 41 facing the electric machine 26. The gear 34 and a sleeve carrier 42 located at the opposite end of the hollow shaft section 41. A shift collar 43 is arranged on the sleeve carrier in a manner known for locking synchronizers so that it cannot rotate, but can be axially displaced by a shifting dog 45 of an actuator that engages into a continuous annular groove. The axial displacement makes it possible for the shift collar 43 to engage with the switching gear teeth 46 of the ring gear 33. The shift collar 43 and switching gear teeth 46 together comprise a claw clutch 44, which establishes a positive connection between the ring gear 33 and second connecting shaft 31. In this engaged position, the entire planetary gear 27 rotates as a rigid block, so that no frictional losses arise between the intermeshing gears 29, 32, 33.

In another manner known for locking synchronizers, a synchronizer ring 47 can be provided between the sleeve carrier 42 and switching gear teeth 46, which is brought into frictional contact with the ring gear 33 by advancing the shift collar 43 against the switching gear teeth, and allows the shift collar 43 to advance into the switching gear teeth 46 only after synchronization is complete.

The multi-plate clutch 37 is open during normal driving operation at speeds above a limit of a few km/h. An electronic control unit controls the actuator, so as to keep the shift collar 43 in a neutral position, not engaged with the switching gear teeth 46, until a desired speed of the vehicle can be maintained by operating the internal combustion engine in an energy-efficient operating point interval. If the torque of the internal combustion engine is insufficient for maintaining the desired speed in this operating point interval, the control unit switches the shift collar 43 into the engaged position on the switching gear teeth 46, and operates the electric machine 26 as a motor to provide the required torque that was not delivered by the internal combustion engine. If the torque of the internal combustion engine is higher than needed for maintaining the desired speed in this operating point interval, the control unit can operate the electric machine 26 as a generator with the shift collar 43 kept in the engaged position, so as to siphon off the excess torque and use it to charge the vehicle battery.

Since the electric machine 26 is coupled to the chassis via the smallest gear 23 of the layshaft 17, the rotational speed of the electric machine 26 can be kept low enough even at high vehicle speeds to prevent any overload caused by centrifugal forces. In the event a vehicle speed does arise at which damage to the electric machine 26 cannot be ruled out, it can be provided that the control unit automatically opens the claw clutch 44 in such a case.

If the vehicle speed lies below the aforementioned limit, the control unit can close the multi-plate clutch 37. Even at a low vehicle speed, the electric machine 26 can in this way run at a rotational speed high enough that the electric machine 26 can itself produce the required driving power, e.g., while parking the vehicle. In particular, the internal combustion engine can thereby remain nonoperational, and exhaust gas emission can be completely avoided.

While driving up a hill, the electric machine 26 can contribute more to the driving power with the multi-plate clutch 37 closed than in the engaged position of the shift collar 43, thereby making it possible to quickly climb a hill, even given a limited power of the internal combustion engine. While driving down a hill, the transmission ratio of the planetary gear 27 increases the delay effect in generator operation, so that the vehicle speed can be kept within reasonable limits, even on a steep hill, without having to use the brakes or drag torque of the internal combustion engine. In this way, the potential energy released while driving down a hill can in large part be converted into electric energy, and stored for renewed use.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment as contemplated herein. It should be understood that various changes may be made in the function and arrangement of elements described in an exemplary embodiment without departing from the scope of the invention as set forth in the appended claims.

1-11. (canceled)

12. A transmission assembly for a hybrid vehicle with a gearbox comprising:
an input shaft configured for coupling to a drive shaft of an internal combustion engine;
a pinion shaft configured for coupling to a chassis component; and
a switchable planetary gear having a first connecting shaft configured for coupling to an electric machine and a second connecting shaft non-rotatably configured for coupling with the pinion shaft;
wherein the planetary gear set is switched between a first position in which a ring gear is non-rotatably coupled to a transmission housing, and a second position in which the ring gear is non-rotatably coupled to a planetary carrier.

13. The transmission assembly according to claim 12, wherein the planetary gear set is switched into a third position wherein the ring gear can freely rotate.

14. The transmission assembly according to claim 12, further comprising a multi-plate clutch configured to selectively couple the ring gear to the transmission housing.

15. The transmission assembly according to claim 12, further comprising a claw clutch configured to selectively couple the ring gear to the planetary carrier.

16. The transmission assembly according to claim 12 further comprising a control unit operable to uncouple the first connecting shaft from the pinion shaft when a speed limit is exceeded.

17. The transmission assembly according to claim 12, further comprising an idler gear operably coupling the second connecting shaft to the pinion shaft.

18. The transmission assembly according to claim 17, further comprising a synchronizer configured to couple the idler gear to the drive shaft.

19. The transmission assembly according to claim 17, further comprising a gear of the pinion shaft in meshing engagement with the idler gear.

20. The transmission assembly according to claim 17, further comprising a gear on a layshaft of the gearbox in meshing engagement with the idler gear, wherein the layshaft gear is smaller than the idler gear.

21. The transmission assembly according to claim 17, wherein the idler gear is larger than a plurality of gears on the drive shaft.

22. The transmission assembly according to claim 12, further comparing a reverse gear shaft overlapping the planetary gear in an axial direction.

23. A drivetrain for a hybrid vehicle comprising:
a first drive shaft of an internal combustion engine;
a second drive shaft of an electric machine;
a gearbox including:
a transmission housing;
an input shaft coupled to the first drive shaft;
a pinion shaft configured for coupling to a chassis component;
a ring gear;
a planetary carrier; and
a switchable planetary gear set having a first connecting shaft selectively coupled to the second drive shaft and a second connecting shaft selectively non-rotatably coupled to the pinion shaft;
wherein the planetary gear set is switchable between a first position in which the ring gear is non-rotatably coupled to the transmission housing, and a second position in which the ring gear is non-rotatably coupled to a planetary carrier.
